(19) United States
(12) Patent Application Publication
(10) Pub. No.: US 2012/0316891 A1
(43) Pub. Date: Dec. 13, 2012

(54) COHORT DRIVEN SELECTION OF A COURSE OF MEDICAL TREATMENT

(75) Inventors: ROBERT R. FRIEDLANDER, SOUTHBURY, CT (US); JAMES R. KRAEMER, SANTA FE, NM (US)

(73) Assignee: INTERNATIONAL BUSINESS MACHINES CORPORATION, ARMONK, NY (US)

(21) Appl. No.: 13/159,076

(22) Filed: Jun. 13, 2011

(51) Int. Cl. G06Q 50/00

(52) U.S. Cl. 705/2

(57) ABSTRACT

A computer implemented method, system, and/or computer program product create a recommended course of medical treatment of a current patient. A current medical diagnosis of a medical condition being suffered by the current patient is used to identify a cohort of other persons who have been diagnosed with the same medical condition as that suffered by the current patient. Past medical treatment procedures used on members of the cohort are sorted according to how closely these medical treatments matched desired results of the current patient and constraints for the current patient. The sorted medical treatment sets are then presented as a recommended course of treatment to a health care provider for the current patient.

### BACKGROUND

The present disclosure relates to the field of computers, and specifically to the use of computers in the field of medicine. Still more particularly, the present disclosure relates to the use of computers in choosing proper medical treatment.

Selecting which medical treatment to administer to a patient is often an inexact science. That is, medical conditions are often treatable by different treatment plans, which may have varying levels of efficacy. If an administered set of treatments turns out to be ineffective for the patient's malady, then time, money, and resources are wasted, and the patient may incur serious harm.

### BRIEF SUMMARY

A computer implemented method, system, and/or computer program product create a recommended course of medical treatment of a current patient. A current medical diagnosis of a medical condition being suffered by the current patient is used to identify a cohort of other persons who have been diagnosed with the same medical condition as that suffered by the current patient. Past medical treatment procedures used on members of the cohort are sorted according to how closely these medical treatments matched desired results of the current patient and constraints for the current patient. The sorted medical treatment sets are then presented to a health care provider as a recommended course of treatment for the current patient.

### BRIEF DESCRIPTION OF THE SEVERAL VIEWS OF THE DRAWINGS

FIG. 1 depicts an exemplary computer in which the present disclosure may be implemented;

FIG. 2 is a high level flow chart of one or more exemplary steps performed by a processor to aid in a determination of an optimal course of treatment for a patient;

FIG. 3 illustrates an exemplary User Interface (UI) for receiving criteria information about the patient;

FIG. 4 is a chart depicting multiple alternative medical treatment sets that have various acceptable/unacceptable outcome levels;

FIG. 5 illustrates multiple alternative medical treatment sets that share a same initial treatment procedure;

FIG. 6 illustrates an exemplary UI presenting tier one information about recommended treatment plans; and

FIG. 7 depicts an exemplary UI presenting tier two information about the same or different recommended treatment plans from FIG. 6.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including, but not limited to, wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

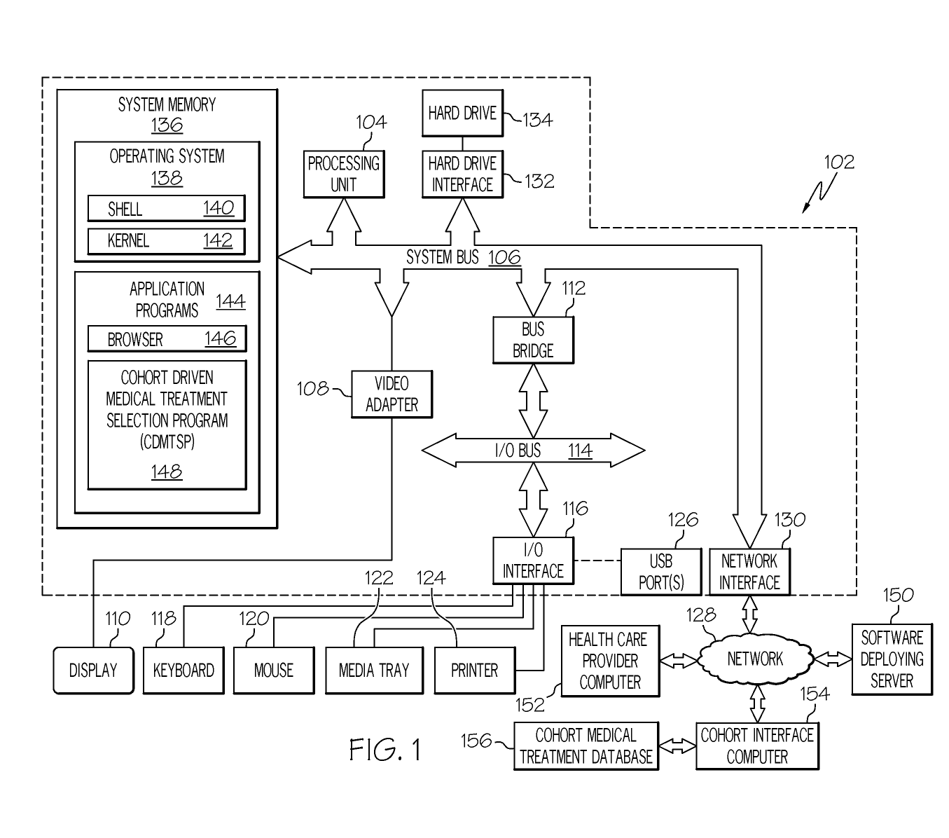

With reference now to the figures, and in particular to FIG. 1, there is depicted a block diagram of an exemplary computer 102, which may be utilized by the present invention. Note that some or all of the exemplary architecture, including both depicted hardware and software, shown for and within computer 102 may be utilized by software deploying server 150, a health care provider computer 152, and/or a cohort interface computer 154.

Computer 102 includes a processing unit 104 that is coupled to a system bus 106. Processing unit 104 may utilize one or more processors, each of which has one or more processor cores. A video adapter 108, which drives/supports a display 110, is also coupled to system bus 106. System bus 106 is coupled via a bus bridge 112 to an input/output (I/O) bus 114. An I/O interface 116 is coupled to I/O bus 114. I/O interface 116 affords communication with various I/O devices, including a keyboard 118, a mouse 120, a media tray 122 (which may include storage devices such as CD-ROM drives, multi-media interfaces, etc.), a printer 124, and external USB port(s) 126. While the format of the ports connected to I/O interface 116 may be any known to those skilled in the art of computer architecture, in one embodiment some or all of these ports are universal serial bus (USB) ports.

As depicted, computer 102 is able to communicate with a software deploying server 150 using a network interface 130. Network 128 may be an external network such as the Internet, or an internal network such as an Ethernet or a virtual private network (VPN).

A hard drive interface 132 is also coupled to system bus 106. Hard drive interface 132 interfaces with a hard drive 134. In one embodiment, hard drive 134 populates a system memory 136, which is also coupled to system bus 106. System memory is defined as a lowest level of volatile memory in computer 102. This volatile memory includes additional higher levels of volatile memory (not shown), including, but not limited to, cache memory, registers and buffers. Data that populates system memory 136 includes computer 102's operating system (OS) 138 and application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a renderer, shown in exemplary manner as a browser 146. Browser 146 includes program modules and instructions enabling a world wide web (WWW) client (i.e., computer 102) to send and receive network messages to the Internet using hypertext transfer protocol (HTTP) messaging, thus enabling communication with software deploying server 150 and other computer systems.

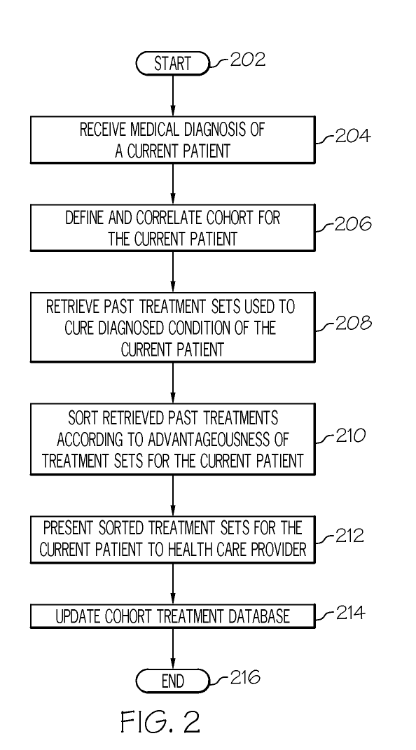

Application programs 144 in computer 102's system memory (and, in one embodiment, software deploying server 150's system memory, health care provider's computer 152) also include a cohort driven medical treatment selection program (CDMTSP) 148. CDMTSP 148 includes code for implementing the processes described below, including those described in FIGS. 2-7. In one embodiment, computer 102 is able to download CDMTSP 148 from software deploying server 150, including in an on-demand basis, wherein the code in CDMTSP 148 is not downloaded until needed for execution to define and/or implement the improved enterprise architecture described herein. Note further that, in one embodiment of the present invention, software deploying server 150 performs all of the functions associated with the present invention (including execution of CDMTSP 148), thus freeing computer 102 from having to use its own internal computing resources to execute CDMTSP 148.

The hardware elements depicted in computer 102 are not intended to be exhaustive, but rather are representative to highlight essential components required by the present invention. For instance, computer 102 may include alternate memory storage devices such as magnetic cassettes, digital versatile disks (DVDs), Bernoulli cartridges, and the like. These and other variations are intended to be within the spirit and scope of the present invention.

Note that, in one embodiment, various combinations of computer 102, health care provider computer 152, and/or cohort interface computer 154 and their functions may be integrated into one or more computers.

Note that while FIG. 1 presents a general architecture of one computing system that may be utilized in one embodiment of the present invention, in another embodiment many processing systems are utilized in parallel. In one such embodiment, these parallel computing systems directly and precisely answer natural language questions over an open and broad range of knowledge identified by Question/Answer (QA) technology that utilizes Natural Language Processing, Information Retrieval, Knowledge Representation and Reasoning, and Machine Learning technologies. This QA technology incorporates hypothesis generation, massive evidence gathering, analysis, and scoring to create an Artificial Intelligence (AI) that allows for a natural QA interaction between a health care provider and the technology described herein. This natural interaction allows the parallel computing systems to deliver precise, meaningful responses, and to synthesize, integrate, and rapidly reason in natural language text.

With reference now to FIG. 2, a high level flow chart of one or more exemplary steps performed by a processor to create and suggest a course of medical treatment for a patient is presented. After initiator block 202, a current medical diagnosis for a current patient is received by a computer, such as computer 102 depicted in FIG. 1, from a computer such as the health care provider computer 152 (also shown in FIG. 1), as described in block 204.

As described in block 206, a processor then defines/retrieves/matches the current patient to a particular cohort. This cohort is made up of persons who each have a substantially similar (or in one embodiment, identical) medical condition as the current patient. In one embodiment, the cohort is further defined/granulated by persons who share medical and/or non-medical attributes of the current patient, as described below.

As described in block 208, the processor then identifies and retrieves, from a cohort medical treatment set database (e.g., a cohort medical treatment database 156 presented via the cohort interface computer 154 shown in FIG. 1) past medical treatment plans that have been used on persons in the cohort. In one embodiment, this retrieval identifies a single set of one or more treatment procedures for the diagnosed medical condition. In another embodiment, this retrieval identifies multiple sets of one or more treatment procedures for the diagnosed medical condition. In order to determine which of the multiple sets is appropriate for the current patient, additional information about the current patient's circumstances are retrieved from the patient and/or the health care provider.

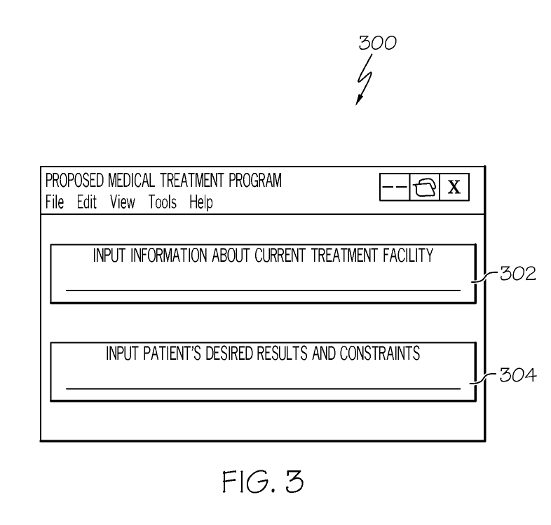

For example, consider exemplary User Interface (UI) 300 shown in FIG. 3. Block 302 allows the health care provider to enter information about the current treatment facility where the patient is being seen. This information describes information about physical resources available at the facility (e.g., types of medical equipment; types of operating rooms, patient rooms, etc., current availability levels of the physical resources; types and quantities of pharmaceutical supplies, medical supplies, blood, etc. currently on hand; etc.). The information about the current treatment facility can be provided by inputting the information into block 302 (using drop-down menus, entry fields, etc.), or by correlating the name/identity of the current treatment facility with resource information stored in another database.

The patient (or the patient's agent) can also enter information in block 304 regarding the patient's desired results, as well as any constraints on the patient. Note that the information described in block 302 identifies some of these constraints on the patient. However, other constraints may be a maximum amount of time, patient pain, resource use, and expended money that the patient is able/willing to sustain. As described herein, in one embodiment some or all of these constraints will be used as weights to adjust a sorting of proposed medical treatment sets. The patient's desired results are described/defined in terms of post-treatment quality of life, and are also used as weights when sorting the proposed medical treatment sets. This post-treatment quality of life includes to what degree the medical condition is cured/alleviated (e.g., is there a requirement for on-going follow-up treatment or is the cure total?); what limitations on daily activities will be suffered (e.g., will mobility/vision/hearing/etc. be lost or limited?; will there be on-going high pain and suffering? etc.); will there be disfigurement?; etc. For example, a certain medical condition may be cured with a high level of certainty by removing a portion of a patient's digestive tract, but the patient may not wish to contend with a stoma appliance. In such a case, another procedure (e.g., chemotherapy) with less certain efficacy may be recommended to the health care provider of the patient.

As described in block 210, the information described above regarding the desires and constraints of the current patient are then used to sort retrieved past treatment sets according to how well the various past treatment sets meet the desires/constraints of the current patient. That is, if a particular set of one or more medical treatments historically has fulfilled most (or all) of the patient's desired results, while operating within the patient/facility restraints, then that set of medical treatments will be ranked higher than another set of medical treatments that does not meet as many of the patient's desires/constraints and/or does not comport as well to the patient/facility restraints.

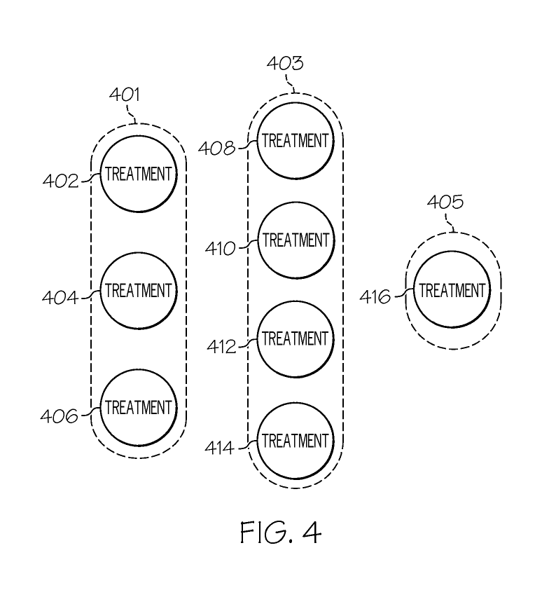

Examples of various past medical treatment procedures sets stored in a cohort medical treatment database are shown in FIG. 4 as past medical treatment sets 401, 403, and 405. In the sets depicted, each of the treatments components 402-416 is unique for each set (i.e., no two sets share a same medical treatment). Thus, the different sets are sorted according to how well they meet the desires of the patient and comport with various constraints. Note that some (i.e., past medical treatment sets 401 and 403) of the past medical treatment sets are made up of multiple treatment components (which may or may not have to be performed in a certain sequence), or a past medical treatment set may be a set of one (e.g., past medical treatment set 405). Whether multiple or singular in composition, the sets may be sorted using weighting, as now described.

In one embodiment, the various past medical treatment sets are weighted according to a raw number of members of the cohort who received the past medical treatment procedures associated with each of the past medical treatment sets. That is, assume that there are two different past medical treatment sets for the cohort. If the first medical treatment set was successfully used by 95% of the members of the cohort while a second medical treatment set was successfully used by the other 5% of the members of the cohort, then the first medical treatment set will be weighted more heavily (i.e., sorted such that it is shown as a first choice of treatment), since it is “tried and true.”

In one embodiment, the various past medical treatment sets are weighted according to a ratio of how many cohort members were successfully cured of the same medical condition being suffered by the current patient as compared to how many cohort members were not cured of the same medical condition being suffered by the current patient. That is, assume that there are two different past medical treatment sets for the cohort, but that the first medical treatment set was effective only 50% of the time, while the second medical treatment set was effective 98% of the time. In this case, the second medical treatment set would be weighted more heavily (i.e., sorted such that it is shown as a first choice of treatment), since it has proven to be more effective.

In one embodiment, the various past medical treatment sets are weighted according to how closely resources required by the past medical treatment procedures match resources of a current health care facility where the current patient is being treated. That is, assume that there are two different past medical treatment sets for the cohort, each having a same 95% success rate. However, the first medical treatment set requires several medical resources (i.e., very high end medical equipment, specialty facilities, exotic medicine, etc.) that are not available to the current patient. In this case, the second medical treatment set that does not require these medical resources will be given a greater weighting.

In one embodiment, the various past medical treatment sets are weighted according to how closely descriptions for the current patient match descriptions of cohort members treated by particular medical treatment sets. That is, assume that there are two different past medical treatment sets for the cohort, each having a same 80% success rate. However, the first medical treatment set was utilized by cohort members who, on average, matched 90% of the various descriptors of the current patient, while the second medical treatment set was utilized by cohort members who, on average, matched only 50% of the various descriptors of the current patient. In this case, the first medical treatment set is given the greater weighting. These patient descriptions may be demographic descriptions (e.g., age, occupation, location of current residence, current income level, etc.) of the patient; past travel histories (e.g., when and where the patient has traveled during some predefined period of time); and/or any experienced traumas by the patient that are not directly attributable to the current complaint of the patient (e.g., the patient may have recently broken a bone in her arm, yet is complaining of tinnitus, which is non-attributable to the broken arm).

Note that in one embodiment, multiple weights may be used for sorting the medical treatment sets using a predefined rule set for the current patient. For example, assume that three of the weighting methodologies described above are to be used for a particular current patient. A rule set can instruct the three weighting methodologies to be given equal influence on the overall sorting process, or the three different weighting methodologies may each have a different level of influence/impact on the overall sorting process.

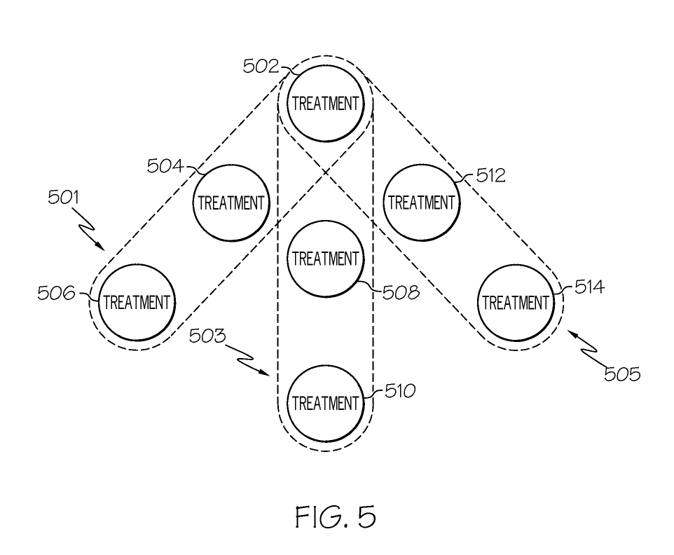

Returning to FIG. 4, note again that each of the past medical treatment sets 401, 403, and 405 are unique (share/overlap no treatment components). However, in one embodiment, as shown in FIG. 5, the past medical treatment sets 501, 503, and 505 found in the cohort medical treatment database do overlap. More specifically, all three treatment sets share a same treatment 502 as an initial treatment step (taken before any other treatment step in the set). After treatment 502 is performed, treatment 504 and then treatment 506 are performed in past medical treatment set 501; and/or treatment 508 and then treatment 510 are performed in past medical treatment set 503; and/or treatment 512 and then treatment 514 are performed in past medical treatment set 505. There may not be an initial understanding as to which of the medical treatment sets are best suited for the current patient, or if multiple medical treatment sets should be used. Thus, if two or more of the past medical treatment sets 501, 503, and 505 are selected for the current treatment as candidate treatment choices, then treatment 502 is started immediately. Thereafter, one or more of the past medical treatment sets are continued (i.e., the remaining medical treatment procedures are performed) according to which of the past medical treatment sets most closely matches the desired results and constraints for the current patient.

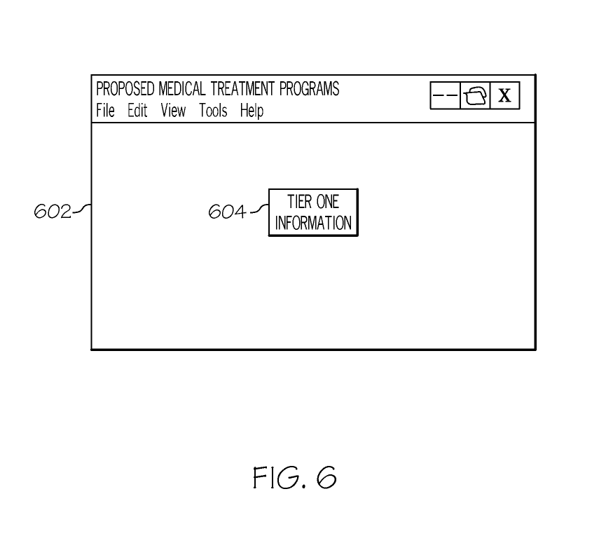

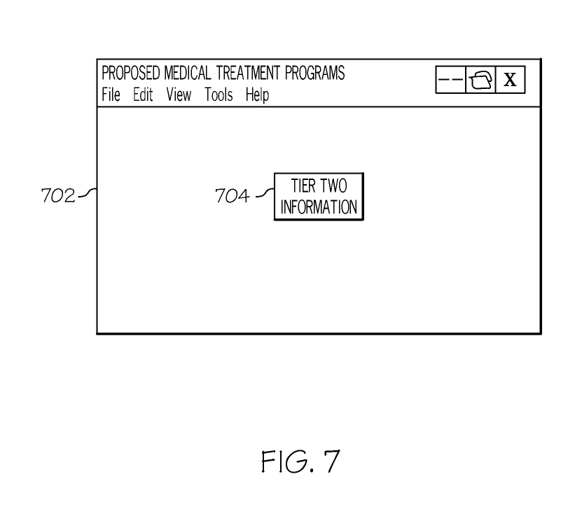

As described in block 212 of FIG. 2, the sorted medical treatment sets are then presented to a health care provider for the current patient. According to the qualifications of and circumstances surrounding a particular health care provider, information related to the sorted (recommended in ranked order) medical treatments sets may vary. Thus, information about the recommended set can be tailored to the particular health care provider, either as Tier One Information (shown in User Interface (UI) 602 of FIG. 6 in a pane 604, or as Tier Two Information (shown in a different UI 702 in a pane 704, as depicted FIG. 7). These two tiers of information may be the same information but with different levels of detail, or they may be different recommended sets of medical treatment sets.

For example, assume that that a first health care provider has a low level of education and/or experience when compared to a second health care provider (as identified by a profile of both health care providers that is accessible to a program such as CDMTSP 148 shown in FIG. 1). The Tier Two Information may provide less detailed instructions to the first health care provider as compared to the level of detail provided to the second health care provider. However, assume now that the two health care providers have the same credentials, but one health care provider is situated with the patient inside a health care facility that is able to immediately treat the medical condition using protocols described by a recommended set of medical treatments, while the other health care provider and the patient are hours or days away from such a facility (e.g., due to geographic distance away from the facility, inability to cross a flooded river or snow covered pass to reach the facility, etc.). In such a case, the protocol that can logistically be performed promptly may be higher ranked, and thus presented to the health care provider.

As shown in block 214 of FIG. 2, once a determination is made that a particular medical treatment course of action was or was not effective, and to what extent, this information is input into the cohort medical treatment database 156 as an update. The process ends at terminator block 216.

As described herein, the present invention provides a significant and novel improvement over the prior art. That is, the present invention provides a health care provider with a recommended set of treatment protocols that historically have higher efficacy levels for persons closely matching attributes of the current patient. Without the use of the cohort methodology presented herein, the efficacy of a particular treatment plan will be known only for the general population, which will be much lower than the efficacy of treatment plans for members of the cohort that match the current patient.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of various embodiments of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Note further that any methods described in the present disclosure may be implemented through the use of a VHDL (VHSIC Hardware Description Language) program and a VHDL chip. VHDL is an exemplary design-entry language for Field Programmable Gate Arrays (FPGAs), Application Specific Integrated Circuits (ASICs), and other similar electronic devices. Thus, any software-implemented method described herein may be emulated by a hardware-based VHDL program, which is then applied to a VHDL chip, such as a FPGA.

Having thus described embodiments of the invention of the present application in detail and by reference to illustrative embodiments thereof, it will be apparent that modifications and variations are possible without departing from the scope of the invention defined in the appended claims.

What is claimed is:

1. A computer implemented method of creating a recommended course of medical treatment for a current patient, the computer implemented method comprising:
a processor receiving a current medical diagnosis of a medical condition being suffered by a current patient;
the processor identifying a cohort for the current patient, wherein the cohort comprises persons who have been diagnosed with the same medical condition being suffered by the current patient;
the processor identifying and retrieving past medical treatment sets of past medical treatment procedures that were used to treat members of the cohort for the same medical condition being suffered by the current patient, wherein the past medical treatment sets are stored in a cohort medical treatment set database;
the processor sorting the past medical treatment sets based on matches, of past results and constraints for members of the cohort, to desired results of the current patient and constraints for the current patient; and
the processor presenting the sorted medical treatment sets as a recommended course of treatment to a health care provider for the current patient.

2. The computer implemented method of claim 1, further comprising:
the processor weighting the past medical treatment sets according to a raw number of members of the cohort who received the past medical treatment procedures associated with each of the past medical treatment sets, wherein said weighting adjusts said sorting.

3. The computer implemented method of claim 1, further comprising:
the processor weighting the past medical treatment sets according to a ratio of how many cohort members were successfully treated for the same medical condition being suffered by the current patient as compared to how many cohort members were not successfully treated for the same medical condition being suffered by the current patient, wherein said weighting adjusts said sorting.

4. The computer implemented method of claim 1, further comprising:
the processor weighting the past medical treatment sets according to how closely resources required by the past medical treatment procedures match resources of a current health care facility where the current patient is being treated, wherein said weighting adjusts said sorting.

5. The computer implemented method of claim 1, further comprising:
the processor weighting the past medical treatment sets according to how closely a result of performing the past medical treatment procedures matches the current patient's desired results in terms of post-treatment quality of life, wherein said weighting adjusts said sorting.

6. The computer implemented method of claim 1, further comprising:
the processor weighting the past medical treatment sets according to how closely constraints on performing the past medical treatment procedures match the current patient's constraints in terms of incurred time, patient pain, resource use, and expended money, wherein said weighting adjusts said sorting.

7. The computer implemented method of claim 1, further comprising:
the processor weighting the past medical treatment sets according to how closely descriptions for the current patient match descriptions of cohort members treated by particular medical treatment sets, wherein the descriptions comprise demographic descriptions and past travel histories.

8. The computer implemented method of claim 1, further comprising:
the processor weighting the past medical treatment sets according to how closely descriptions for the current patient match descriptions of cohort members treated by particular medical treatment sets, wherein the descriptions comprise an experienced trauma that is not directly attributable to the current medical complaint of the current patient.

9. The computer implemented method of claim 1, further comprising:
determining a level of effectiveness to which a chosen medical treatment set cures the current patient; and
updating the cohort medical treatment database with the level of effectiveness to which a chosen medical treatment set cures the current patient.

10. The computer implemented method of claim 1, wherein at least two of the sorted medical treatment sets are sets of multiple sequential medical treatment sets for a same medical condition, and wherein the computer implemented method further comprises:
the processor selecting two of the sets of multiple sequential medical treatment sets that have a same initial medical treatment procedure;
the processor determining which of the two sets of multiple sequential medical treatment sets is a matching medical treatment set that more closely matches the desired results and constraints for the current patient;
the processor transmitting a recommendation to execute the same initial medical treatment procedure on the current patient at an initial time; and
the processor transmitting a recommendation to execute remaining medical treatment procedures, from the matching medical treatment set, on the current patient at a later time.

11. The computer implemented method of claim 1, further comprising:
the processor modifying displayed information about the sorted medical treatment sets according to a profile of the health care provider for the current patient, wherein the profile of the health care provider for the current patient is an education level of the health care provider for the current patient.

12. The computer implemented method of claim 1, further comprising:
the processor modifying displayed information about the sorted medical treatment sets according to a profile of the health care provider for the current patient, wherein the profile of the health care provider for the current patient is a health care experience level of the health care provider for the current patient.

13. The computer implemented method of claim 1, further comprising:
the processor modifying displayed information about the sorted medical treatment sets according to a profile of the health care provider for the current patient, wherein the profile of the health care provider for the current patient is a temporal proximity of the health care provider to a nearest treatment facility that is capable of treating the medical condition being suffered by the current patient.

14. The computer implemented method of claim 1, wherein at least one of the past medical treatment sets is a set of one.

15. A computer program product for creating a recommended course of medical treatment of a current patient, the computer program product comprising:
a computer readable storage media;
first program instructions to receive a current medical diagnosis of a medical condition being suffered by a current patient;
second program instructions to identify a cohort for the current patient, wherein the cohort comprises persons who have been diagnosed with the same medical condition being suffered by the current patient;
third program instructions to identify and retrieve past medical treatment sets of medical treatment procedures that were used to treat members of the cohort for the same medical condition being suffered by the current patient, wherein the past medical treatment sets are stored in a cohort medical treatment set database;
fourth program instructions to sort the past medical treatment sets based on matches, of past results and constraints for members of the cohort, to desired results of the current patient and constraints for the current patient; and
fifth program instructions to present the sorted medical treatment sets as a recommended course of medical treatment to a health care provider for the current patient; and wherein the first, second, third, fourth, and fifth program instructions are stored on the computer readable storage media.

16. The computer program product of claim 15, further comprising:
sixth program instructions for weighting the past medical treatment sets according to a raw number of members of the cohort who received the past medical treatment procedures associated with each of the past medical treatment sets, wherein the weighting adjusts said sorting; and wherein the sixth program instructions are stored on the computer readable storage media.

17. The computer program product of claim 15, further comprising:
sixth program instructions for weighting the past medical treatment sets according to how closely resources required by the past medical treatment procedures match resources of a current health care facility where the current patient is being treated, wherein said weighting adjusts said sorting; and wherein the sixth program instructions are stored on the computer readable storage media.

18. A computer system comprising:
a processor, a computer readable memory, and a computer readable storage media;
first program instructions to receive a current medical diagnosis of a medical condition being suffered by a current patient;
second program instructions to identify a cohort for the current patient, wherein the cohort comprises persons who have been diagnosed with the same medical condition being suffered by the current patient;
third program instructions to identify and retrieve past medical treatment sets of medical treatment procedures that were used to treat members of the cohort for the same medical condition being suffered by the current patient, wherein the past medical treatment sets are stored in a cohort medical treatment set database;
fourth program instructions to sort the past medical treatment sets based on matches, of past results and constraints for members of the cohort, to desired results of the current patient and constraints for the current patient; and
fifth program instructions to present the sorted medical treatment sets as a recommended course of treatment to a health care provider for the current patient; and wherein the first, second, third, fourth, and fifth program instructions are stored on the computer readable storage media for execution by the processor via the computer readable memory.

19. The computer system of claim 18, further comprising:
sixth program instructions for weighting the past medical treatment sets according to a raw number of members of the cohort who received the past medical treatment procedures associated with each of the past medical treatment sets, wherein the weighting adjusts said sorting; and wherein the sixth program instructions are stored on the computer readable storage media for execution by the processor via the computer readable memory.

20. The computer system of claim 18, further comprising:
sixth program instructions for weighting the past medical treatment sets according to how closely resources required by the past medical treatment procedures match resources of a current health care facility where the current patient is being treated, wherein said weighting adjusts said sorting; and wherein the sixth program instructions are stored on the computer readable storage media for execution by the processor via the computer readable memory.
